(19) United States
(12) Patent Application Publication
(10) Pub. No.: US 2024/0086865 A1
(43) Pub. Date: Mar. 14, 2024

(54) VEHICLE REPAIR ESTIMATION GUIDED BY ARTIFICIAL INTELLIGENCE

(71) Applicant: Mitchell International, Inc., San Diego, CA (US)

(72) Inventors: Abhijeet Gulati, San Diego, CA (US); Dune Pagaduan, San Diego, CA (US); Marcel De Neve, San Diego, CA (US); David Beumer, San Diego, CA (US); Tran Huyen Tran, San Diego, CA (US); Olivier Baudoux, San Diego, CA (US)

(73) Assignee: Mitchell International, Inc., San Diego, CA (US)

(21) Appl. No.: 18/462,246

(22) Filed: Sep. 6, 2023

Related U.S. Application Data
(60) Provisional application No. 63/405,804, filed on Sep. 12, 2022.
(60) Provisional application No. 63/423,715, filed on Nov. 8, 2022.

(51) Int. Cl. G06Q 10/20; G06T 7/00; G06V 10/94; G06V 20/50

(52) U.S. Cl. CPC G06Q 10/20; G06T 7/0002; G06V 10/945; G06V 20/50; G06T 2200/24; G06T 2207/20081

(57) ABSTRACT

A computer-implemented method comprises: generating a user interface operable by a user to generate one or more vehicle repair estimate lines for repairing a damaged vehicle and/or request an automated review of the line(s); generating one or more first vehicle repair estimate lines, adding the one or more first vehicle repair estimate lines to a vehicle repair estimate data structure, and presenting a first view of the data structure in the user interface; obtaining images of the damaged vehicle, providing the images to one or more trained machine learning (ML) models, which provide first output comprising second vehicle repair estimate lines for the vehicle repair estimate, adding second vehicle repair estimate lines to the data structure, and presenting a second view of the data structure in the user interface; and generating a vehicle repair estimation document based on the vehicle repair estimate data structure.

### CROSS REFERENCE TO RELATED APPLICATIONS

The present application claims priority to U.S. Provisional Patent Application No. 63/405,804, filed Sep. 12, 2022, entitled “VEHICLE REPAIR ESTIMATION GUIDED BY ARTIFICIAL INTELLIGENCE” and U.S. Provisional Patent Application No. 63/423,715, filed Nov. 8, 2022, entitled “VEHICLE REPAIR ESTIMATION GUIDED BY ARTIFICIAL INTELLIGENCE”, the disclosures thereof incorporated by reference herein in their entirety.

### DESCRIPTION OF RELATED ART

The disclosed technology relates generally to estimates for vehicle repair, and more particularly some embodiments relate to generating cost estimates for vehicle repair.

### SUMMARY

In general, one aspect disclosed features a system for automatically guiding completion of a vehicle repair estimation document, the system comprising: a hardware processor; and a non-transitory machine-readable storage medium encoded with instructions executable by the hardware processor to cause the system to perform operations comprising: generating a user interface comprising one or more first active display elements operable by a user to generate one or more vehicle repair estimate lines for repairing a damaged vehicle and a second active display element operable by the user to request an automated review of the one or more lines; responsive to operation of one or more first active display elements, generating one or more first vehicle repair estimate lines for repairing the damaged vehicle, adding the one or more first vehicle repair estimate lines to a vehicle repair estimate data structure, and presenting a first view of the vehicle repair estimate data structure in the user interface; responsive to operation of the second active display element: obtaining one or more images of the damaged vehicle, providing the one or more images to one or more trained machine learning (ML) models, wherein responsive to the one or more images the one or more trained ML models provide first output comprising one or more second vehicle repair estimate lines for repairing the damaged vehicle, and wherein the one or more trained ML models are trained using historical examples of images of damaged vehicles and corresponding vehicle repair estimate lines, adding the one or more second vehicle repair estimate lines to the vehicle repair estimate data structure, and presenting a second view of the vehicle repair estimate data structure in the user interface, including one or more of the one or more second vehicle repair estimate lines; after presenting a second view of the vehicle repair estimate data structure and responsive to operation of a third active display element in the user interface, the third active display element operable by the user to commit the vehicle repair estimate, generating a vehicle repair estimation document based on the vehicle repair estimate data structure.

Embodiments of the system may include one or more of the following features. In some embodiments, the user interface comprises a fourth active display element operable by the user to request automated generation of one or more third vehicle repair estimate lines for repairing the damaged vehicle; and responsive to operation of the fourth active display element, the operations further comprise: providing the one or more images to the one or more trained ML models, wherein responsive to the one or more images the one or more trained ML models provide second output comprising the one or more third vehicle repair estimate lines, and adding the one or more third vehicle repair estimate lines to the vehicle repair estimate data structure; and the operations further comprise presenting a third view of the vehicle repair estimate data structure in the user interface, including one or more of the one or more third vehicle repair estimate lines. In some embodiments, the operations further comprise: after presenting the second view of the vehicle repair estimate data structure and responsive to operation of a fourth active display element in the user interface, the fourth active display element operable by the user to commit the vehicle repair estimate, generating a vehicle repair estimation document based on the vehicle repair estimate data structure. In some embodiments, the first output of the one or more trained ML models comprises relevance values for the one or more second vehicle repair estimate lines; and the operations further comprise adding the relevance values to the vehicle repair estimate data structure in association with the one or more second vehicle repair estimate lines, and ordering the one or more second vehicle repair estimate lines in the second view of the vehicle repair estimate data structure in the user interface according to the relevance values. In some embodiments, the one or more trained ML models are further configured to: determine a point of impact on the damaged vehicle based on the one or more images of the damaged vehicle; and determine the relevance values based on the point of impact. In some embodiments, the first output of the one or more trained ML models comprises damage severity values for the one or more second vehicle repair estimate lines; and the operations further comprise presenting, in the second view of the vehicle repair estimate data structure, only those of the one or more second lines having damage severity values that exceed a damage severity threshold. In some embodiments, the operations further comprise: obtaining one or more training data sets comprising the historical images of damaged vehicles and corresponding vehicle repair estimate lines; and training the one or more trained machine learning models using the training data set.

In general, one aspect disclosed features one or more non-transitory machine-readable storage media encoded with instructions that, when executed by one or more hardware processors of a computing system, cause the computing system to perform operations for automatically guiding completion of a vehicle repair estimation document, the operations comprising: generating a user interface comprising one or more first active display elements operable by a user to generate one or more vehicle repair estimate lines for repairing a damaged vehicle and a second active display element operable by the user to request an automated review of the one or more lines; responsive to operation of one or more first active display elements, generating one or more first vehicle repair estimate lines for repairing the damaged vehicle, adding the one or more first vehicle repair estimate lines to a vehicle repair estimate data structure, and presenting a first view of the vehicle repair estimate data structure in the user interface; responsive to operation of the second active display element: obtaining one or more images of the damaged vehicle, providing the one or more images to one or more trained machine learning (ML) models, wherein responsive to the one or more images the one or more trained ML models provide first output comprising one or more second vehicle repair estimate lines for repairing the damaged vehicle, and wherein the one or more trained ML models are trained using historical examples of images of damaged vehicles and corresponding vehicle repair estimate lines, adding the one or more second vehicle repair estimate lines to the vehicle repair estimate data structure, and presenting a second view of the vehicle repair estimate data structure in the user interface, including one or more of the one or more second vehicle repair estimate lines; after presenting a second view of the vehicle repair estimate data structure and responsive to operation of a third active display element in the user interface, the third active display element operable by the user to commit the vehicle repair estimate, generating a vehicle repair estimation document based on the vehicle repair estimate data structure.

Embodiments of the one or more non-transitory machine-readable storage media may include one or more of the following features. In some embodiments, the user interface comprises a fourth active display element operable by the user to request automated generation of one or more third vehicle repair estimate lines for the vehicle repair estimate; and responsive to operation of the fourth active display element, the operations further comprise: providing the one or more images to the one or more trained ML models, wherein responsive to the one or more images the one or more trained ML models provide second output comprising the one or more third vehicle repair estimate lines, and adding the one or more third vehicle repair estimate lines to the vehicle repair estimate data structure; and the operations further comprise presenting a third view of the vehicle repair estimate data structure in the user interface, including one or more of the one or more third vehicle repair estimate lines. In some embodiments, the operations further comprise: after presenting the second view of the vehicle repair estimate data structure and responsive to operation of a fourth active display element in the user interface, the fourth active display element operable by the user to commit the vehicle repair estimate, generating a vehicle repair estimation document based on the vehicle repair estimate data structure. In some embodiments, the first output of the one or more trained ML models comprises relevance values for the one or more second vehicle repair estimate lines; and the operations further comprise adding the relevance values to the vehicle repair estimate data structure in association with the one or more second vehicle repair estimate lines, and ordering the one or more second vehicle repair estimate lines in the second view of the vehicle repair estimate data structure in the user interface according to the relevance values. In some embodiments, the one or more trained ML models are further configured to: determine a point of impact on the damaged vehicle based on the one or more images of the damaged vehicle; and determine the relevance values based on the point of impact. In some embodiments, the first output of the one or more trained ML models comprises damage severity values for the one or more second vehicle repair estimate lines; and the operations further comprise presenting, in the second view of the vehicle repair estimate data structure, only those of the one or more second lines having damage severity values that exceed a damage severity threshold. In some embodiments, the operations further comprise: obtaining one or more training data sets comprising the historical images of damaged vehicles and corresponding vehicle repair estimate lines; and training the one or more trained machine learning models using the training data set. In some embodiments, the operations further comprise: obtaining one or more training data sets comprising the historical images of damaged vehicles and corresponding vehicle repair estimate lines; and training the one or more trained machine learning models using the training data set.

In general, one aspect disclosed features a computer-implemented method for automatically guiding completion of a vehicle repair estimation document, the method comprising: generating a user interface comprising one or more first active display elements operable by a user to generate one or more vehicle repair estimate lines for repairing a damaged vehicle and a second active display element operable by the user to request an automated review of the one or more lines; responsive to operation of one or more first active display elements, generating one or more first vehicle repair estimate lines for repairing the damaged vehicle, adding the one or more first vehicle repair estimate lines to a vehicle repair estimate data structure, and presenting a first view of the vehicle repair estimate data structure in the user interface; responsive to operation of the second active display element: obtaining one or more images of the damaged vehicle, providing the one or more images to one or more trained machine learning (ML) models, wherein responsive to the one or more images the one or more trained ML models provide first output comprising one or more second vehicle repair estimate lines for repairing the damaged vehicle, and wherein the one or more trained ML models are trained using historical examples of images of damaged vehicles and corresponding vehicle repair estimate lines, adding the one or more second vehicle repair estimate lines to the vehicle repair estimate data structure, and presenting a second view of the vehicle repair estimate data structure in the user interface, including one or more of the one or more second vehicle repair estimate lines; after presenting a second view of the vehicle repair estimate data structure and responsive to operation of a third active display element in the user interface, the third active display element operable by the user to commit the vehicle repair estimate, generating a vehicle repair estimation document based on the vehicle repair estimate data structure.

Embodiments of the computer-implemented method may include one or more of the following features. In some embodiments, the user interface comprises a fourth active display element operable by the user to request automated generation of one or more third vehicle repair estimate lines for the vehicle repair estimate; and responsive to operation of the fourth active display element, the computer-implemented method comprises: providing the one or more images to the one or more trained ML models, wherein responsive to the one or more images the one or more trained ML models provide second output comprising the one or more third vehicle repair estimate lines, and adding the one or more third vehicle repair estimate lines to the vehicle repair estimate data structure; and the operations further comprise presenting a third view of the vehicle repair estimate data structure in the user interface, including one or more of the one or more third vehicle repair estimate lines. Some embodiments comprise: after presenting the second view of the vehicle repair estimate data structure and responsive to operation of a fourth active display element in the user interface, the fourth active display element operable by the user to commit the vehicle repair estimate, generating a vehicle repair estimation document based on the vehicle repair estimate data structure. In some embodiments, the first output of the one or more trained ML models comprises relevance values for the one or more second vehicle repair estimate lines; and the operations further comprise adding the relevance values to the vehicle repair estimate data structure in association with the one or more second vehicle repair estimate lines, and ordering the one or more second vehicle repair estimate lines in the second view of the vehicle repair estimate data structure in the user interface according to the relevance values. In some embodiments, the one or more trained ML models are further configured to: determine a point of impact on the damaged vehicle based on the one or more images of the damaged vehicle; and determine the relevance values based on the point of impact. In some embodiments, the first output of the one or more trained ML models comprises damage severity values for the one or more second vehicle repair estimate lines; and the operations further comprise presenting, in the second view of the vehicle repair estimate data structure, only those of the one or more second lines having damage severity values that exceed a damage severity threshold.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a vehicle repair estimation system according to some embodiments of the disclosed technology.

FIG. 2 is a flowchart illustrating a process for vehicle repair estimation guided by artificial intelligence according to some embodiments of the disclosed technologies.

FIG. 3 depicts an example “Damage Overview” user interface according to some embodiments of the disclosed technology.

FIG. 4 depicts an example “Focused Damage” screen based on the “Damage Overview” screen of FIG. 3.

FIG. 5 depicts an example updated “Focused Damage” screen based on the “Focused Damage” screen of FIG. 4.

FIG. 6 is a flowchart illustrating a process for vehicle repair estimation guided by artificial intelligence according to some embodiments of the disclosed technologies.

FIG. 7 is an example computing component that may be used to implement various features of embodiments described in the present disclosure.

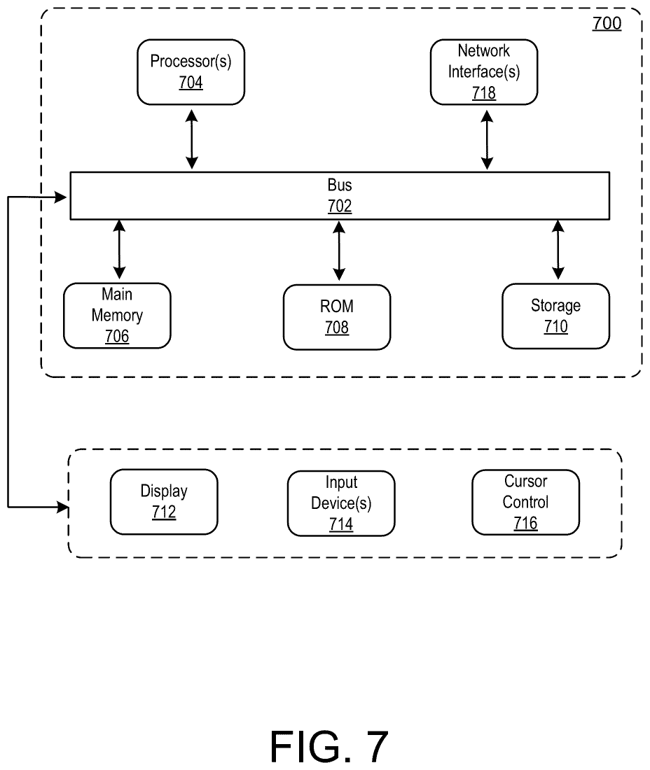

The figures are not exhaustive and do not limit the present disclosure to the precise form disclosed.

### DETAILED DESCRIPTION

Embodiments of the disclosed technologies provide vehicle repair estimation guided by artificial intelligence. These embodiments create more accurate repair estimates than prior solutions, and create those estimates more quickly and with less labor than prior solutions.

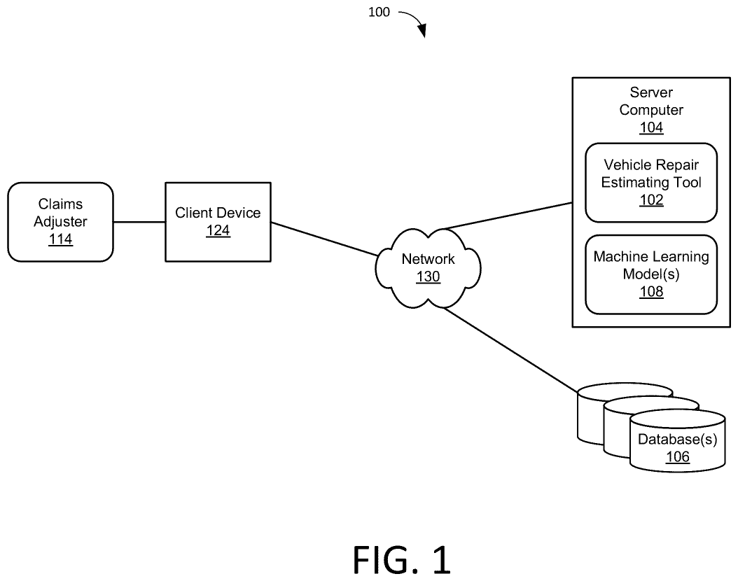

FIG. 1 illustrates a vehicle repair estimation system 100 according to some embodiments of the disclosed technology. The system 100 may include a Vehicle Repair Estimating Tool 102. The tool 102 may be implemented as one or more software packages executing on one or more server computers 104. The tool 102 may include one or more artificial intelligence functions such as machine learning models 108. The machine learning models 108 may be implemented in any manner. The machine learning models 108 may be implemented as trained machine learning models, for example as described below. The system 100 may include one or more databases 106. In some embodiments, the databases 106 may store rules for execution by the tool 102. The rules may include preestablished compliance rules. In some embodiments, the databases 106 may store electronic vehicle repair estimate records and related images of damaged vehicles.

Multiple users may interact with the tool 102. For example, referring to FIG. 1, the users may include a claims adjuster 114, and the like. Each user may employ a respective device or system. The claims adjuster 114 may employ a client device 124. Each device may be implemented as a computer, smart phone, smart glasses, electronic embedded computers and displays, and the like. Each user may employ the client device or hardware to access the tool 102 over a network 130 such as the Internet.

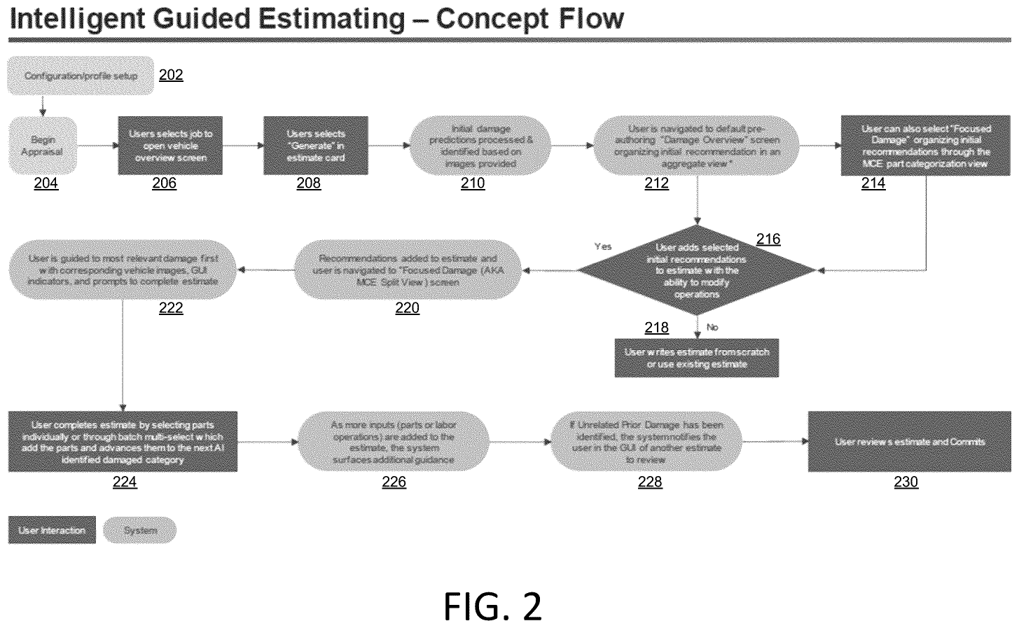

FIG. 2 is a flowchart illustrating a process 200 for vehicle repair estimation guided by artificial intelligence according to some embodiments of the disclosed technologies. The elements of the process 200 are presented in one arrangement. However, it should be understood that one or more elements of the process may be performed in a different order, in parallel, omitted entirely, and the like. Furthermore, the process 200 may include other elements in addition to those presented. For example, the process 200 may include error-handling functions if exceptions occur, and the like. Portions of the process 200 may be performed by the Vehicle Repair Estimating Tool 102 of FIG. 1.

Referring to FIG. 2, the process 200 may include configuration and profile setup, at 202. The profiles may include individual profiles for vehicles according to factors such as year, make, and model of the vehicles. In the example of FIG. 1, the configuration and profiles may be stored in the database(s) 106.

Referring again to FIG. 2, the estimation process 200 may include the generation of an estimate, which may be initiated by a user on a user interface, at 204. In some embodiments, the process 200 may be guided interactively by artificial intelligence.

The user may select a particular damaged vehicle repair to estimate, at 206. In response, the tool 102 may provide a vehicle overview screen that includes an estimate card, at 206. The user may then select a “generate” button in the estimate card to invoke automated estimate generation, at 208. In response, the tool 102 may obtain images of the damaged vehicle, and based on those images, provide initial damage predictions, at 210. The tool 102 may provide those initial damage predictions in a “Damage Overview” screen, at 212. Generation of the initial damage predictions may be performed partially or wholly by an artificial intelligence function.

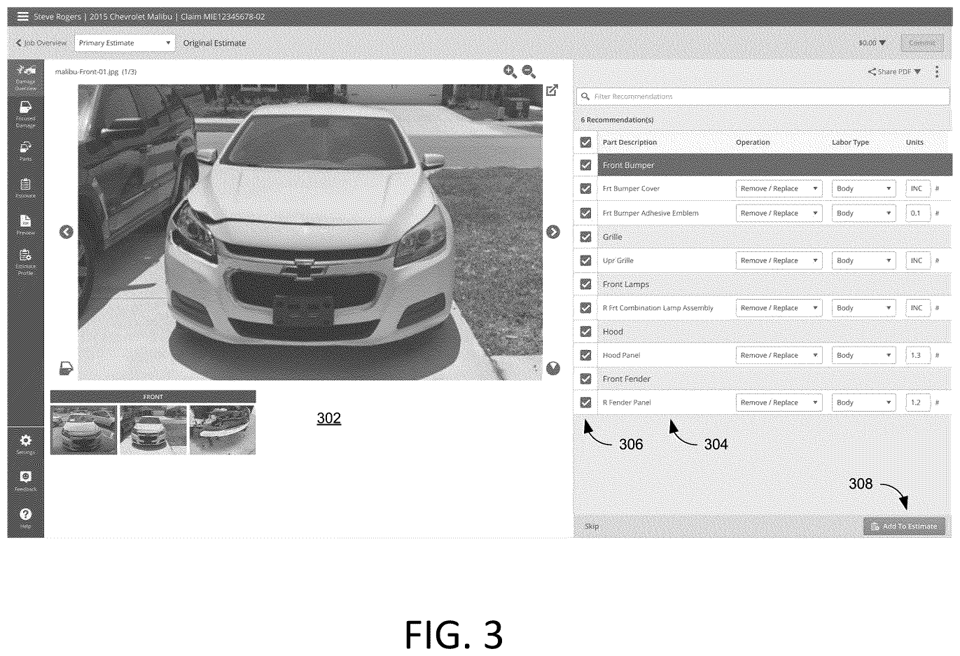

FIG. 3 depicts an example “Damage Overview” user interface according to some embodiments of the disclosed technology. Referring to FIG. 3, this user interface may include one or more display elements. The display elements may include the images of the damaged vehicle, at 302. The display elements may include descriptions of the initial damage predictions (also referred to herein as “recommendations”), at 304, and for each of the recommendations, a respective active display element operable by the user to select or unselect the recommendation, at 306. The display elements may include a button operable to add the selected recommendations to the estimate, at 308. That is, the artificial intelligence function recommends components to add to the estimate.

Referring again to FIG. 2, the tool 102 may enable the user to select one or more of the recommended components to add to the estimate by operating active display elements of the user interface, at 216. The tool 102 may also enable the user to select a screen to organize the initial recommendations prior to this selection, at 214, for example by operating display element 308 of the user interface of FIG. 3. Alternatively, instead of selecting any of the recommendations, the tool 102 may enable the user to provide this information manually, at 218.

The tool then navigates the user to a “Focused Damage” screen where the current estimate is displayed, at 220. This screen may guide the user to the most relevant damage first, and may provide corresponding images of the vehicle, along with other display elements such as UI indicators and prompts to complete the estimate, at 222.

The tool 102 may enable the user to complete the estimate, at 224. The user may select parts individually, or using a batch multi-select of multiple parts. The tool 102 may then guide the user to the next damage category, which may be identified by the artificial intelligence functions.

As more parts or labor operations are added to the estimate, the tool 102 may update the user interface to surface additional guidance to the user, at 226, for example using the artificial intelligence functions. The additional guidance may be based on suggested parts selected by the user, as well as suggested parts selected by the tool 102.

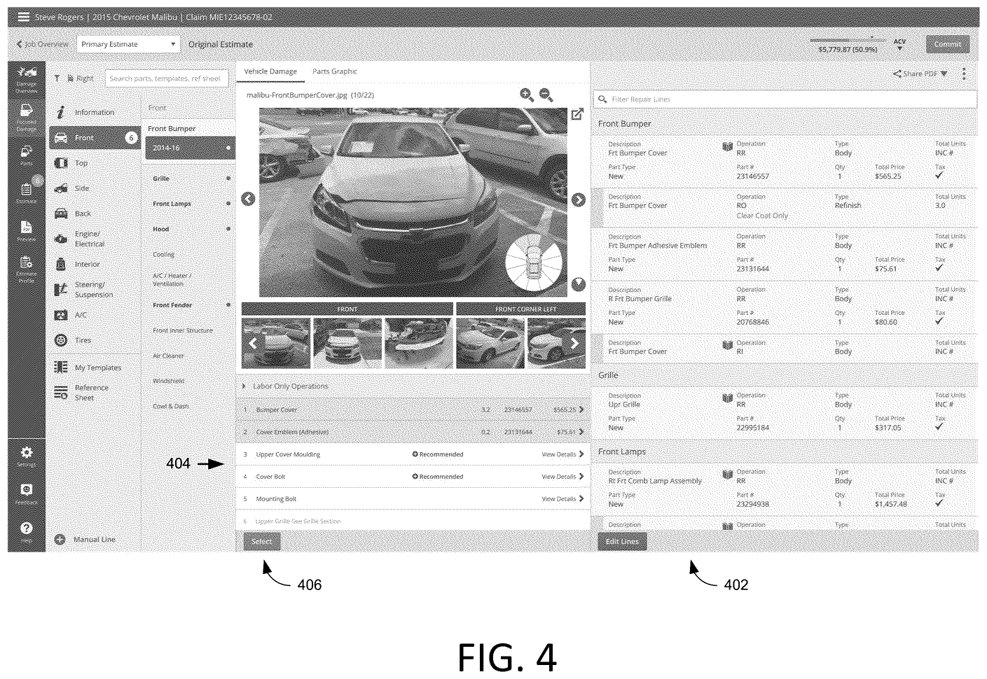

FIG. 4 depicts an example “Focused Damage” screen based on the “Damage Overview” screen of FIG. 3. Referring to FIG. 4, this user interface may include one or more display elements. Responsive to the user adding the recommendations suggested by the tool 102 to the estimate in the example of FIG. 3, the tool 102 has presented more detail regarding those recommendations, at display elements 402. In addition, the tool 102 has made two additional recommendations, for an Upper Cover Moulding and a Cover Bolt, at 404. The user may agree, adding these components to the estimate, by operating display element 406.

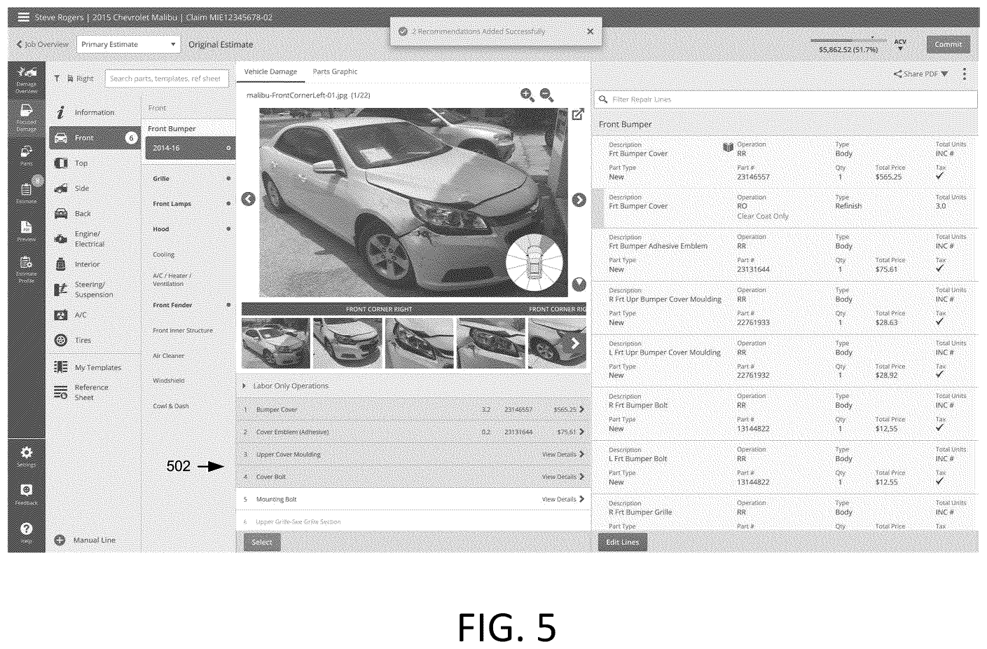

FIG. 5 depicts an example updated “Focused Damage” screen that has been updated responsive to the user accepting the tool's additional recommendations by operating display element 404 in FIG. 4. Referring to FIG. 5, those recommendations are now included in the estimate, as shown at 502.

In some embodiments, the tool 102 may determine whether the images of the vehicle depict prior damage that occurred prior to the current damage event, and may notify the user of such prior damage, at 228. The user may use the tool 102 to generate a new estimate to address the prior damage, or to simply exclude the prior damage from the current estimate.

Finally, the user may review the estimate, and if satisfied with the estimate, may commit the estimate, at 230.

The disclosed user interface may be considered as a notebook having several pages. The first page is used for estimate generation. This page is the starting point that allows an estimator to manually start the estimate with what he/she believes to be the main factors dictating the estimate write up. The estimator may also choose one or more computer vision models to provide initial seed line inputs if the user chooses not to manually start the pre-estimate write up. The first page may have the action of generating a preliminary estimate (either manually or automated using computer vision models). A second page of the notebook is the damage overview. This page couples the human decisions that were made manually (in the first page), and triggers AI/ML models that further facilitate inclusion of additional decisions, analogous to filling in blanks. A third page is a focused page. This page further allows for inclusion, exclusion, and edits to the AI/ML disposition and has the ability to apply rules such as optimal parts selection for example along with editorial logic with data dictionaries. The tool 102 may also enable a user to perform a break-even analysis that may influence decisions.

The tool 102 gives the user the freedom to go back to first page, and re-edit the manual entries chosen or updates from computer models by including additional assets like images or video streams. This automatically refreshes the focused page with new decisions. All this can occur in real time.

FIG. 5 is a flowchart illustrating a process 500 for vehicle repair estimation guided by artificial intelligence according to some embodiments of the disclosed technologies. The elements of the process 500 are presented in one arrangement. However, it should be understood that one or more elements of the process may be performed in a different order, in parallel, omitted entirely, and the like. Furthermore, the process 500 may include other elements in addition to those presented. For example, the process 500 may include error-handling functions if exceptions occur, and the like. Portions of the process 500 may be performed by the Vehicle Repair Estimating Tool 102.

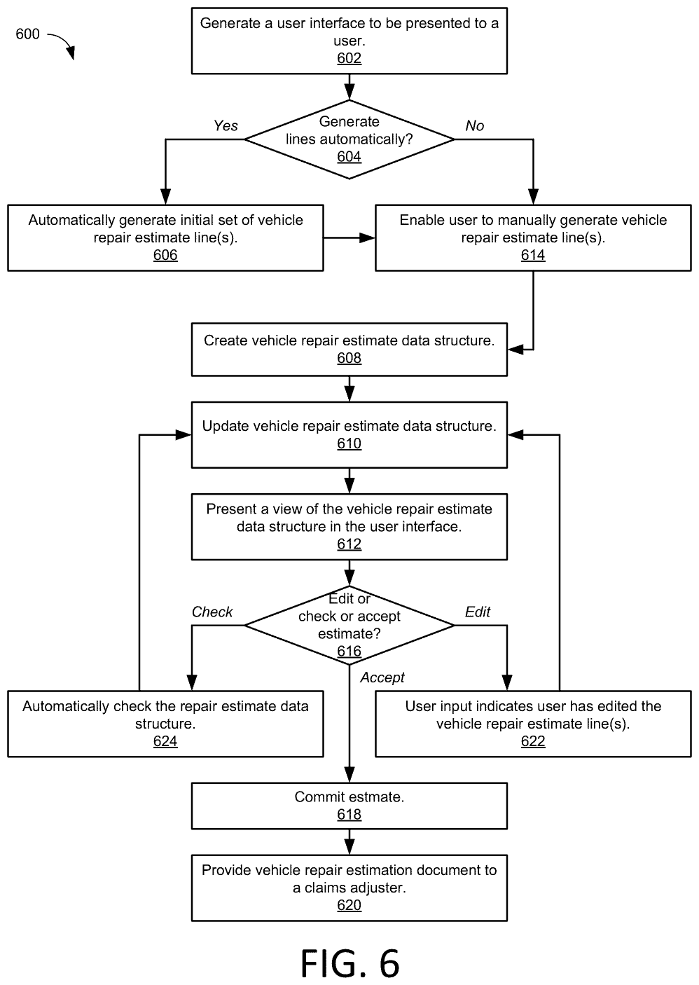

Referring to FIG. 6, the process 600 may include generating a user interface to be presented to a user, at 602. The user interface may enable the user to decide whether to begin generating an initial set of vehicle repair estimate lines automatically or manually, at 604. 6 6 6 6 6For example, Responsive to the user electing to generate vehicle repair estimate lines manually, the tool 102 may enable the user to generate vehicle repair estimate lines manually, at 614. The user interface may include one or more active display elements operable by the user to manually generate one or more vehicle repair estimate lines for repairing the damaged vehicle. The process 600 may include creating a vehicle repair estimate data structure, at 608, updating the vehicle repair estimate data structure, at 610, in this instance by adding the manually-generated initial set of vehicle repair estimate lines to the vehicle repair estimate data structure, and presenting a view of the resulting vehicle repair estimate data structure in the user interface, at 612. For example, the view may include some or all of the “Focused Damage” screens of FIGS. 4 and 5 and/or the “Damage Overview” screen of FIG. 3.

Alternatively, the user interface may include an active display element operable by the user to request automated generation of one or more initial vehicle repair estimate lines, at 604. Responsive to operation of that element, the tool 102 may automatically generate an initial set of vehicle repair estimate lines for repairing the damaged vehicle, at 606, using one or more automated processes, as described in detail below. The tool 102 may then enable the user to generate vehicle repair estimate lines manually, at 614. The tool 102 may also enable the user to edit the automatically-generated vehicle repair estimate lines. The process 600 may include creating a vehicle repair estimate data structure, at 608, updating the vehicle repair estimate data structure, at 610, in this instance by adding the automatically-generated initial set of vehicle repair estimate lines, and any manually-generated vehicle repair estimate lines, to the vehicle repair estimate data structure, and presenting a view of the resulting vehicle repair estimate data structure in the user interface, at 612. For example, the view may include some or all of the “Focused Damage” screen of FIGS. 4 and 5 and/or the “Damage Overview” screen of FIG. 3.

Referring again to FIG. 6, the user interface may enable the user to accept the current estimate, to manually edit the estimate, or to request the tool 102 automatically check the estimate, at 616. Responsive to user input indicating the user accepts the estimate, the process 600 may include committing the estimate, at 618, and may include generating a vehicle repair estimation document based on the vehicle repair estimate data structure, and providing the vehicle repair estimation document to a claims adjuster, at 620.

Responsive to user input indicating the user has manually edited the estimate, at 622, the process may include updating the vehicle repair estimate data structure and presenting a view of the updated vehicle repair estimate data structure in the user interface, returning to 610.

Responsive to user input indicating the user requested the tool 102 automatically check the estimate, the tool 102 may automatically check the estimate, at 620, using one or more automated processes, as described in detail below. For example, the tool 102 may check whether the estimate conforms to preestablished compliance rules. When the automatic check is complete, the process may include may include updating the vehicle repair estimate data structure and presenting a view of the updated vehicle repair estimate data structure in the user interface, returning to 610.

The automated processes described above for generating vehicle repair estimate lines may include the use of trained machine learning models. The automated processes described above for checking estimates may include the use of business rules, editorial databases, and/or trained machine learning models. In the example of FIG. 1, the business rules and editorial databases may be stored in databases 106.

During the checking process, compliance rules may be applied to the vehicle repair estimate data structure to add, remove, or modify individual vehicle repair estimate lines, or to provide corresponding recommendations. Similarly, the data in the vehicle repair estimate data structure may be used to index the editorial databases to add, remove, or modify individual vehicle repair estimate lines, or to provide corresponding recommendations.

During generating vehicle repair estimate lines and/or checking estimates, the disclosed technologies may include the use of one or more trained machine learning models at one or more points in the described processes. Any machine learning models may be used. For example, the machine learning models and techniques may include classifiers, decision trees, neural networks, gradient boosting, and similar machine learning models and techniques. For example, for generating vehicle repair estimate lines, a neural network may be trained and applied to receive as input one or more images of a damaged vehicle, and may provide as output a generated vehicle repair estimate data structure comprising one or more new vehicle repair estimate lines. For example, for checking vehicle repair estimate lines, a neural network may be trained and applied to receive as input a vehicle repair estimate data structure comprising one or more vehicle repair estimate lines and one or more images of a corresponding damaged vehicle, and may provide as output a modified vehicle repair estimate data structure.

The training data may involve creating mapping rules. For example, the mapping rules may define adjacent parts across all exterior panels. The training data may be curated Curation of the training data may include creating a knowledge graph relating panels of a vehicle to historical operations on those panels of the vehicle. The panels may further be decomposed to include specific components within the panels. Knowledge graphs of adjacent panels and/or components may be presented as the input of the model training.

The neural network may include a feature extraction layer that extracts features from the input data. In some embodiments, this process may be performed after input data preprocessing. The preprocessing may include input data transformation. The input data transformation may include converting different file types (e.g., image and/or video stream format, word format, etc.) into a unified digital format (e.g., pdf file). The preprocessing may include data extraction. The data extraction may include extracting useful information, for example using optical character recognition (OCR) and natural language processing (NLP) techniques.

The feature extraction in the feature extraction layer may be performed against the extracted data. The features for extraction may include identifiers of damaged parts identified in the images of the damaged vehicles. The features for extraction may include vehicle repair estimate lines in the vehicle repair estimate data structure. The selection of the features for extraction may also be determined by learning importance scores for the candidate features using a tree-based machine learning model.

For example, the tree-based machine learning model for feature selection may use Random Forests or Gradient Boosting. The model includes an ensemble of decision trees that collectively make predictions. To begin, the tree-based model may be trained on a labeled dataset. The dataset may include historical images of damaged vehicles and/or historical vehicle repair estimate data structures, along with corresponding output vehicle repair estimate data structures. The selected historical electronic vehicle diagnostic records may be used as the ground truth labels for training purposes.

As the tree-based machine learning model learns to make predictions, it recursively splits the data based on different features, constructing a tree structure that captures patterns in the data. The goal of the training is to make the predictions as close to the ground truth labels as possible. One of the advantages of tree-based models is that they can generate feature importance scores for each input feature. These scores reflect the relative importance of each feature in contributing to the model's predictive power. A higher importance score indicates that a feature has a greater influence on the model's decision-making process.

In some embodiments, Gini importance metric may be used for feature importance in the tree-based model. Gini importance quantifies the total reduction in the Gini impurity achieved by each feature across all the trees in the ensemble. Features that lead to a substantial decrease in impurity when used for splitting the data are assigned higher importance scores.

Once the tree-based model is trained, the feature importance scores may be extracted. By sorting the features in descending order based on their scores, a ranked list of features may be obtained. This ranking enables prioritizing the features that have the most impact on the model's decision-making process.

Based on the feature ranking, the top features may be extracted from incoming images of damaged vehicles and/or vehicle repair estimate data structures and fed into the neural network to output vehicle repair estimate data structures including new and modified vehicle repair estimate lines.

The neural network may include an output layer that provides output data based on the input data. For example, the output layer of a classifier may use a sigmoid activation function that outputs a probability value between 0 and 1 for each class.

For example, the selection process described above for the Vehicle Repair Estimating Tool 102 may be implemented using a trained machine learning model. The model may be trained using training data that reflect historical vehicle repair estimate data structures and historical images of damaged vehicles and corresponding output vehicle repair estimate data structures. In some embodiments, the training data may include scores and weights of these records, as well as thresholds employed with the scoring.

In some embodiments, the output of the one or more trained machine learning models includes relevance values for the vehicle repair estimate lines. In such embodiments, the tool 102 may add the relevance values to the vehicle repair estimate data structure in association with the corresponding vehicle repair estimate lines, and may order the vehicle repair estimate lines in the view of the vehicle repair estimate data structure in the user interface according to the relevance values. In some embodiments, the one or more trained machine learning models may determine a point of impact on the damaged vehicle based on the one or more images of the damaged vehicle, and may determine the relevance values based on the point of impact.

In some embodiments, the output of the one or more trained machine learning models may include damage severity values for the repair estimate lines. In some embodiments, these values may be used to limit the number of lines presented to the user in the user interface. For example, only those lines having damage severity values that exceed a damage severity threshold may be displayed.

During inference operation, these electronic records may be provided as inference input data to a trained machine learning model. An input layer of the model may extract one or more parameters as input data from the electronic records. Responsive to the inference input, an output layer of the model may provide output representing a selection probability for each electronic vehicle diagnostic record.

Some embodiments include the training of the machine learning models. The training may be supervised, unsupervised, or a combination thereof, and may continue between operations for the lifetime of the system. The training may include creating a training set that includes the input parameters and corresponding assessments described above.

The training may include one or more second stages. A second stage may follow the training and use of the trained machine learning models, and may include creating a second training set, and training the trained machine learning models using the second training set. The second training set may include the inputs applied to the machine learning models, and the corresponding outputs generated by the machine learning models, during actual use of the machine learning models.

The second training stage may include identifying erroneous assessments generated by the machine learning model, and adding the identified erroneous assessments to the second training set. Creating the second training set may also include adding the inputs corresponding to the identified erroneous assessments to the second training set.

Different iterations may employ the same trained machine learning model and/or different trained machine learning models. For example, a first iteration may employ a cosine similarity or machine model. A second iteration may employ an auto encoder, STOSA, or machine model. A third iteration may employ a group NN or machine model. Subsequent iterations may employ a STOSA or machine model.

Embodiments of the disclosed technologies include features that provide numerous advantages. These features include the automatic generation of vehicle repair estimate lines as well as accuracy checking of the vehicle repair estimate lines even while writing the estimate, which may be considered similar to spell checking while writing. For example, marked gains in cycle time efficiency are achieved. The advantages also include a more engaged user experience with reduced error rates resulting in highly accurate estimate write ups, and higher agreement rates when validating predictions prior to populating and committing to the estimate. These features allow an organized approach towards straight through processing of qualified (low touch) claims.

FIG. 6 depicts a block diagram of an example computer system 600 in which embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or a WAN component to communicate with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

What is claimed is:

1. A system for automatically guiding completion of a vehicle repair estimation document, the system comprising:
a hardware processor; and
a non-transitory machine-readable storage medium encoded with instructions executable by the hardware processor to cause the system to perform operations comprising:
generating a user interface comprising one or more first active display elements operable by a user to generate one or more vehicle repair estimate lines for repairing a damaged vehicle and a second active display element operable by the user to request an automated review of the one or more lines;
responsive to operation of one or more first active display elements, generating one or more first vehicle repair estimate lines for repairing the damaged vehicle, adding the one or more first vehicle repair estimate lines to a vehicle repair estimate data structure, and presenting a first view of the vehicle repair estimate data structure in the user interface;
responsive to operation of the second active display element:
obtaining one or more images of the damaged vehicle,
providing the one or more images to one or more trained machine learning (ML) models, wherein responsive to the one or more images the one or more trained ML models provide first output comprising one or more second vehicle repair estimate lines for repairing the damaged vehicle, and wherein the one or more trained ML models are trained using historical examples of images of damaged vehicles and corresponding vehicle repair estimate lines,
adding the one or more second vehicle repair estimate lines to the vehicle repair estimate data structure, and
presenting a second view of the vehicle repair estimate data structure in the user interface, including one or more of the one or more second vehicle repair estimate lines;
after presenting a second view of the vehicle repair estimate data structure and responsive to operation of a third active display element in the user interface, the third active display element operable by the user to commit the vehicle repair estimate, generating a vehicle repair estimation document based on the vehicle repair estimate data structure.

2. The system of claim 1, wherein:
the user interface comprises a fourth active display element operable by the user to modify the one or more second vehicle repair estimate lines prior to committing the vehicle repair estimate;
the user interface comprises a fifth active display element operable by the user to add one or more third vehicle repair estimate lines prior to committing the vehicle repair estimate; and
the user interface comprises a sixth active display element operable by the user to check the vehicle repair estimate using compliance rules prior to committing the vehicle repair estimate.

3. The system of claim 1, wherein:
the user interface comprises a fourth active display element operable by the user to request automated generation of one or more third vehicle repair estimate lines for repairing the damaged vehicle; and
responsive to operation of the fourth active display element, the operations further comprise:
providing the one or more images to the one or more trained ML models, wherein responsive to the one or more images the one or more trained ML models provide second output comprising the one or more third vehicle repair estimate lines, and
adding the one or more third vehicle repair estimate lines to the vehicle repair estimate data structure; and
the operations further comprise presenting a third view of the vehicle repair estimate data structure in the user interface, including one or more of the one or more third vehicle repair estimate lines.

4. The system of claim 1, the operations further comprising:
providing the vehicle repair estimation document to a claims adjuster.

5. The system of claim 1, wherein:
the first output of the one or more trained ML models comprises relevance values for the one or more second vehicle repair estimate lines; and
the operations further comprise
adding the relevance values to the vehicle repair estimate data structure in association with the one or more second vehicle repair estimate lines, and
ordering the one or more second vehicle repair estimate lines in the second view of the vehicle repair estimate data structure in the user interface according to the relevance values.

6. The system of claim 5, wherein the one or more trained ML models are further configured to:
determine a point of impact on the damaged vehicle based on the one or more images of the damaged vehicle; and
determine the relevance values based on the point of impact.

7. The system of claim 1, wherein:
the first output of the one or more trained ML models comprises damage severity values for the one or more second vehicle repair estimate lines; and
the operations further comprise presenting, in the second view of the vehicle repair estimate data structure, only those of the one or more second lines having damage severity values that exceed a damage severity threshold.

8. The system of claim 1, the operations further comprising:
obtaining one or more training data sets comprising the historical images of damaged vehicles and corresponding vehicle repair estimate lines; and
training the one or more trained machine learning models using the training data set.

9. One or more non-transitory machine-readable storage media encoded with instructions that, when executed by one or more hardware processors of a computing system, cause the computing system to perform operations for automatically guiding completion of a vehicle repair estimation document, the operations comprising:
generating a user interface comprising one or more first active display elements operable by a user to generate one or more vehicle repair estimate lines for repairing a damaged vehicle and a second active display element operable by the user to request an automated review of the one or more lines;
responsive to operation of one or more first active display elements, generating one or more first vehicle repair estimate lines for repairing the damaged vehicle, adding the one or more first vehicle repair estimate lines to a vehicle repair estimate data structure, and presenting a first view of the vehicle repair estimate data structure in the user interface;
responsive to operation of the second active display element:
obtaining one or more images of the damaged vehicle,
providing the one or more images to one or more trained machine learning (ML) models, wherein responsive to the one or more images the one or more trained ML models provide first output comprising one or more second vehicle repair estimate lines for repairing the damaged vehicle, and wherein the one or more trained ML models are trained using historical examples of images of damaged vehicles and corresponding vehicle repair estimate lines,
adding the one or more second vehicle repair estimate lines to the vehicle repair estimate data structure, and
presenting a second view of the vehicle repair estimate data structure in the user interface, including one or more of the one or more second vehicle repair estimate lines;
after presenting a second view of the vehicle repair estimate data structure and responsive to operation of a third active display element in the user interface, the third active display element operable by the user to commit the vehicle repair estimate, generating a vehicle repair estimation document based on the vehicle repair estimate data structure.

10. The one or more non-transitory machine-readable storage media of claim 9, wherein:
the user interface comprises a fourth active display element operable by the user to modify the one or more second vehicle repair estimate lines prior to committing the vehicle repair estimate;
the user interface comprises a fifth active display element operable by the user to add one or more third vehicle repair estimate lines prior to committing the vehicle repair estimate; and
the user interface comprises a sixth active display element operable by the user to check the vehicle repair estimate using compliance rules prior to committing the vehicle repair estimate.

11. The one or more non-transitory machine-readable storage media of claim 9, wherein:
the user interface comprises a fourth active display element operable by the user to request automated generation of one or more third vehicle repair estimate lines for repairing the damaged vehicle; and
responsive to operation of the fourth active display element, the operations further comprise:
providing the one or more images to the one or more trained ML models, wherein responsive to the one or more images the one or more trained ML models provide second output comprising the one or more third vehicle repair estimate lines, and
adding the one or more third vehicle repair estimate lines to the vehicle repair estimate data structure; and
the operations further comprise presenting a third view of the vehicle repair estimate data structure in the user interface, including one or more of the one or more third vehicle repair estimate lines.

12. The one or more non-transitory machine-readable storage media of claim 9, the operations further comprising:
providing the vehicle repair estimation document to a claims adjuster.

13. The one or more non-transitory machine-readable storage media of claim 9, wherein:
the first output of the one or more trained ML models comprises relevance values for the one or more second vehicle repair estimate lines; and
the operations further comprise
adding the relevance values to the vehicle repair estimate data structure in association with the one or more second vehicle repair estimate lines, and
ordering the one or more second vehicle repair estimate lines in the second view of the vehicle repair estimate data structure in the user interface according to the relevance values.

14. The one or more non-transitory machine-readable storage media of claim 13, wherein the one or more trained ML models are further configured to:
determine a point of impact on the damaged vehicle based on the one or more images of the damaged vehicle; and
determine the relevance values based on the point of impact.

15. The one or more non-transitory machine-readable storage media of claim 9, wherein:
the first output of the one or more trained ML models comprises damage severity values for the one or more second vehicle repair estimate lines; and
the operations further comprise presenting, in the second view of the vehicle repair estimate data structure, only those of the one or more second lines having damage severity values that exceed a damage severity threshold.

16. The one or more non-transitory machine-readable storage media of claim 9, the operations further comprising:
obtaining one or more training data sets comprising the historical images of damaged vehicles and corresponding vehicle repair estimate lines; and
training the one or more trained machine learning models using the training data set.

17. A computer-implemented method for automatically guiding completion of a vehicle repair estimation document, the method comprising:
generating a user interface comprising one or more first active display elements operable by a user to generate one or more vehicle repair estimate lines for repairing a damaged vehicle and a second active display element operable by the user to request an automated review of the one or more lines;
responsive to operation of one or more first active display elements, generating one or more first vehicle repair estimate lines for repairing the damaged vehicle, adding the one or more first vehicle repair estimate lines to a vehicle repair estimate data structure, and presenting a first view of the vehicle repair estimate data structure in the user interface;
responsive to operation of the second active display element:
obtaining one or more images of the damaged vehicle,
providing the one or more images to one or more trained machine learning (ML) models, wherein responsive to the one or more images the one or more trained ML models provide first output comprising one or more second vehicle repair estimate lines for repairing the damaged vehicle, and wherein the one or more trained ML models are trained using historical examples of images of damaged vehicles and corresponding vehicle repair estimate lines,
adding the one or more second vehicle repair estimate lines to the vehicle repair estimate data structure, and
presenting a second view of the vehicle repair estimate data structure in the user interface, including one or more of the one or more second vehicle repair estimate lines;
after presenting a second view of the vehicle repair estimate data structure and responsive to operation of a third active display element in the user interface, the third active display element operable by the user to commit the vehicle repair estimate, generating a vehicle repair estimation document based on the vehicle repair estimate data structure.

18. The computer-implemented method of claim 17, wherein:
the user interface comprises a fourth active display element operable by the user to modify the one or more second vehicle repair estimate lines prior to committing the vehicle repair estimate; and
the user interface comprises a fifth active display element operable by the user to add one or more third vehicle repair estimate lines prior to committing the vehicle repair estimate; and
the user interface comprises a sixth active display element operable by the user to check the vehicle repair estimate using compliance rules prior to committing the vehicle repair estimate.

19. The computer-implemented method of claim 17, wherein:
the user interface comprises a fourth active display element operable by the user to request automated generation of one or more third vehicle repair estimate lines for repairing the damaged vehicle; and
responsive to operation of the fourth active display element, the computer-implemented method comprises:
providing the one or more images to the one or more trained ML models, wherein responsive to the one or more images the one or more trained ML models provide second output comprising the one or more third vehicle repair estimate lines, and
adding the one or more third vehicle repair estimate lines to the vehicle repair estimate data structure; and
the operations further comprise presenting a third view of the vehicle repair estimate data structure in the user interface, including one or more of the one or more third vehicle repair estimate lines.

20. The computer-implemented method of claim 17, further comprising:
providing the vehicle repair estimation document to a claims adjuster.

21. The computer-implemented method of claim 17, wherein:
the first output of the one or more trained ML models comprises relevance values for the one or more second vehicle repair estimate lines; and
the operations further comprise
adding the relevance values to the vehicle repair estimate data structure in association with the one or more second vehicle repair estimate lines, and
ordering the one or more second vehicle repair estimate lines in the second view of the vehicle repair estimate data structure in the user interface according to the relevance values.

22. The computer-implemented method of claim 21, wherein the one or more trained ML models are further configured to:
determine a point of impact on the damaged vehicle based on the one or more images of the damaged vehicle; and
determine the relevance values based on the point of impact.

23. The computer-implemented method of claim 17, wherein:
the first output of the one or more trained ML models comprises damage severity values for the one or more second vehicle repair estimate lines; and
the operations further comprise presenting, in the second view of the vehicle repair estimate data structure, only those of the one or more second lines having damage severity values that exceed a damage severity threshold.
